(19) United States
(12) Patent Application Publication
(10) Pub. No.: US 2025/0284089 A1
(43) Pub. Date: Sep. 11, 2025

(54) OPTICAL ELEMENT DRIVE MECHANISM

(71) Applicant: TDK TAIWAN CORP., Taoyuan City (TW)

(72) Inventors: Po-Xiang ZHUANG, Taoyuan City (TW); Jui-Ta CHIEN, Taoyuan City (TW); Shou-Jen LIU, Taoyuan City (TW); Kun-Shih LIN, Taoyuan City (TW); Yi-Ho CHEN, Taoyuan City (TW); Ko-Lun CHAO, Taoyuan City (TW)

(21) Appl. No.: 19/073,390

(22) Filed: Mar. 7, 2025

Related U.S. Application Data
(60) Provisional application No. 63/562,767, filed on Mar. 8, 2024.

(51) Int. Cl. G02B 7/09; G02B 27/64; G03B 13/36

(52) U.S. Cl. CPC G02B 7/09; G02B 27/646; G03B 13/36

(57) ABSTRACT

An optical element drive mechanism is provided. The optical element drive mechanism has a central axis. The optical element drive mechanism includes an immovable part, a first movable part, and a first drive assembly. The immovable part includes a bottom. The first movable part is connected to a first optical element. The first movable part is movable relative to the bottom. The first drive assembly drives the first movable part to move relative to the bottom.

### CROSS REFERENCE TO RELATED APPLICATIONS

This application claims the benefit of U.S. Provisional Application No. 63/562,767, filed on Mar. 8, 2024, the entirety of which is incorporated by reference herein.

### BACKGROUND OF THE INVENTION

### Field of the Invention

The present disclosure relates to an optical element drive mechanism, and, in particular, to an optical element drive mechanism including a plurality of circuit elements.

### Description of the Related Art

As technology has developed, many electronic devices (such as tablet computers and smartphones) may be used for capturing images and recording video. The optical element and the optical element drive mechanism in the electronic device allow the user to use the electronic device to capture images and record video. When the electronic device is being used, shock or vibration may occur, and this may cause the images or video to come out blurry. Therefore, the demand for higher quality images and video is increasing.

### BRIEF SUMMARY OF THE INVENTION

An optical element drive mechanism having a central axis is provided. The optical element drive mechanism includes an immovable part, a first movable part, and a first drive assembly. The immovable part includes a bottom. The first movable part is connected to a first optical element. The first movable part is movable relative to the bottom. The first drive assembly drives the first movable part to move relative to the bottom.

In some embodiments, the optical element drive mechanism further includes a first-side circuit element electrically connected to the first drive assembly. The bottom includes an embedded circuit, and the first-side circuit element includes a first portion of the first-side circuit element having a plate-like structure, and the first portion of the first-side circuit element is disposed on the bottom. The first portion of the first-side circuit element includes an electrical connection portion of the first-side circuit element, and the first portion of the first-side circuit element is electrically connected to the embedded circuit of the bottom via the electrical connection portion of the first-side circuit element. The bottom includes a bottom first surface facing the first portion of the first-side circuit element, and when viewed along a direction that is perpendicular to the central axis, the bottom first surface is located between a center of the first movable part and the first portion of the first-side circuit element.

### BRIEF DESCRIPTION OF THE DRAWINGS

The present disclosure can be more fully understood by reading the detailed description and examples with references made to the accompanying drawings. It should be noted that various features may be not drawn to scale. In fact, the dimensions of the various features may be arbitrarily increased or decreased for clarity of discussion, and the various features may be drawn schematically.

FIG. 1 is a perspective view of the optical element drive mechanism in accordance with some embodiments.

FIG. 2 is an exploded view of the optical element drive mechanism in accordance with some embodiments.

FIG. 3 is a schematic view of the casing in accordance with some embodiments.

FIG. 4 is a schematic view of the mounting element in accordance with some embodiments.

FIG. 5 is a schematic view of the bottom in accordance with some embodiments.

FIG. 6 is a perspective view of the first movable part in accordance with some embodiments.

FIG. 7 is a perspective view of the second movable part in accordance with some embodiments.

FIG. 8A, FIG. 8B, and FIG. 8C are schematic views illustrating the operation of the second drive assembly in driving the second movable part in accordance with some embodiments.

FIG. 9 is a schematic view of the first-side circuit element and the third-side circuit element in accordance with some embodiments.

FIG. 10 is a schematic view of the external connection circuit element in accordance with some embodiments.

FIG. 11 and FIG. 12 are schematic views of the bottom and the circuit assembly from different perspectives in accordance with some embodiments.

FIG. 13, FIG. 14, and FIG. 15 are perspective views of the optical element drive mechanism with the casing omitted from different perspectives in accordance with some embodiments.

FIG. 16 is a top view of the optical element drive mechanism with the casing omitted in accordance with some embodiments.

FIG. 17 and FIG. 18 are perspective views of the optical element drive mechanism with the casing, the mounting element, and the second movable part omitted in accordance with some embodiments.

FIG. 19 is a cross-sectional view of the optical element drive mechanism with the casing omitted in accordance with some embodiments.

### DETAILED DESCRIPTION OF THE INVENTION

The following description provides different embodiments, or examples, for implementing different features of the present disclosure. In addition, spatially relative terms may be used in the following description to describe the arrangements of various features. These spatially relative terms are for ease of describing the positional relationship between one feature and another feature as illustrated in the drawings. These spatially relative terms are intended to encompass different orientations of the device in use or operation in addition to the orientation illustrated in the drawings. The device may be otherwise oriented (rotated 90 degrees or at other orientations), and the spatially relative terms used in the following description may likewise be interpreted accordingly. For example, if a device of the drawings is flipped upside down, a feature that is “above” will become a feature that is “below”.

For example, the formation of a first feature “on,” “over,” or “under” a second feature in the following description may include embodiments in which the first and second features are formed in direct contact, and may also include embodiments in which additional features may be formed between the first feature and the second feature, such that the first feature and the second feature are not in direct contact.

In the following description, the terms “including”, “comprising”, “having”, and the like should be interpreted as meaning “including but not limited to . . . ”. Therefore, when the terms “including”, “comprising”, “having”, and the like are used, the presence of corresponding features, regions, steps, operations and/or elements is specified, and without excluding the presence of other features, regions, steps, operations and/or elements.

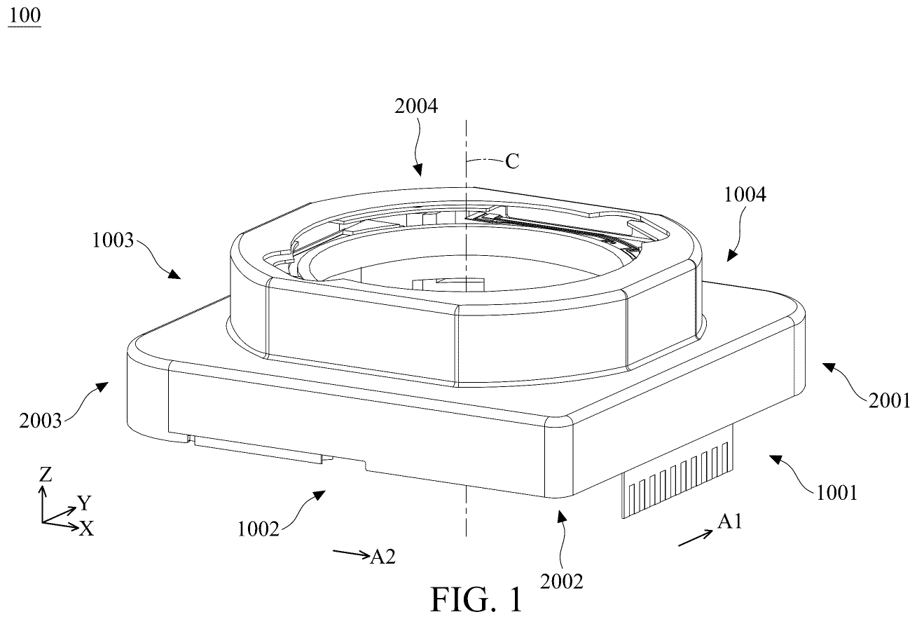

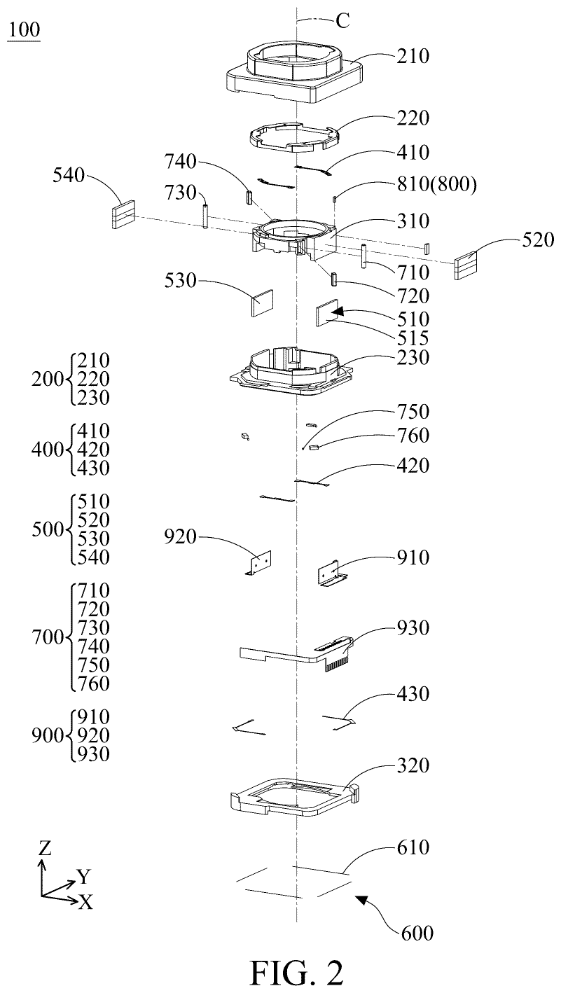

Please refer to FIG. 1 and FIG. 2 to understand an optical element drive mechanism 100. FIG. 1 is a perspective view of the optical element drive mechanism 100 in accordance with some embodiments. FIG. 2 is an exploded view of the optical element drive mechanism 100 in accordance with some embodiments.

The optical element drive mechanism 100 has a central axis C. The central axis C is an imaginary axis passing through the center of the optical element drive mechanism 100. When viewed along the central axis C, the optical element drive mechanism 100 is polygonal. For ease of explanation, the four sides of the optical element drive mechanism 100 are defined as a first side 1001, a second side 1002, a third side 1003, and a fourth side 1004. The first side 1001 is opposite to the third side 1003, and the second side 1002 is opposite to the fourth side 1004. The first side 1001 is substantially parallel with the third side 1003, and the second side 1002 is substantially parallel with the fourth side 1004. The first side 1001, the second side 1002, the third side 1003, and the fourth side 1004 are substantially perpendicular to the central axis C.

When viewed along the central axis C, the first side 1001 and the third side 1003 are parallel with a first axis A1 and extend along the first axis A1. When viewed along the central axis C, the second side 1002 and the fourth side 1004 are parallel with a second axis A2 and extend along the second axis A2. The first axis A1 and the second axis A2 are substantially perpendicular to the central axis C.

In addition, the four corners of the optical element drive mechanism 100 are defined as a first corner 2001, a second corner 2002, a third corner 2003, and a fourth corner 2004. The first corner 2001 is located between the first side 1001 and the fourth side 1004. The second corner 2002 is located between the first side 1001 and the second side 1002. The third corner 2003 is located between the second side 1002 and the third side 1003. The fourth corner 2004 is located between the third side 1003 and the fourth side 1004.

The optical element drive mechanism 100 includes an immovable part 200, a first movable part 310, a second movable part 320, an elastic assembly 400, a first drive assembly 500, a second drive assembly 600, a guiding assembly 700, a position sensing assembly 800, and a circuit assembly 900.

Both the first movable part 310 and the second movable part 320 are able to move relative to the immovable part 200. The elastic assembly 400 is connected to the first movable part 310 and the immovable part 200, and the elastic assembly 400 is connected to the second movable part 320 and the immovable part 200. The first drive assembly 500 can drive the first movable part 310 to move relative to the immovable part 200 along the central axis C, focusing on the object to be captured, thereby achieving auto focus (AF). The second drive assembly 600 can drive the second movable part 320 to move relative to the immovable part 200 along the first axis A1 and the second axis A2, compensating for displacement caused by user-induced shaking or external impact, thereby achieving optical image stabilization (OIS). The guiding assembly 700 may guide the movement of the first movable part 310 and the movement of the second movable part 320. The position sensing assembly 800 can detect the movement of the first movable part 310. The circuit assembly 900 may transmit current.

The immovable part 200 includes a casing 210, a mounting element 220, and a bottom 230. The elastic assembly 400 includes a plurality of first elastic elements 410, two pop-up elastic elements 420, and two second elastic elements 430. The first drive assembly 500 includes a first-side coil 510, a first-side magnetic element 520, a third-side coil 530, and a third-side magnetic element 540. The second drive assembly 600 includes a plurality of drive elements 610.

The guiding assembly 700 includes a second-corner guiding element 710, a second-corner magnetic element 720, a fourth-corner guiding element 730, a fourth-corner magnetic element 740, a plurality of guiding spherical elements 750, and a plurality of guiding magnetic elements 760. The position sensing assembly 800 includes a position sensing element 810. The circuit assembly 900 includes a first-side circuit element 910, a third-side circuit element 920, and an external connection circuit element 930. The description is merely an example. The elements can be added or omitted according to actual needs.

A first optical element (not shown), a second optical element (not shown), and a third optical element (not shown) can cooperate with the optical element drive mechanism 100. The first optical element may be disposed in the first movable part 310, and the movement of the first movable part 310 may drive the first optical element to move. The first optical element may be one or more lenses, which may be made of plastic or glass.

The second optical element may be mounted to the second movable part 320, and the movement of the second movable part 320 may drive the second optical element to move. The second optical element may be an image sensor, such as a charge-coupled device (CCD) or a complementary metal oxide semiconductor (CMOS) image sensor (CIS). Light may be imaged onto the second optical element. The third optical element can be placed over the optical element drive mechanism 100. The third optical element may be an aperture that controls the amount of light entering the optical element drive mechanism 100.

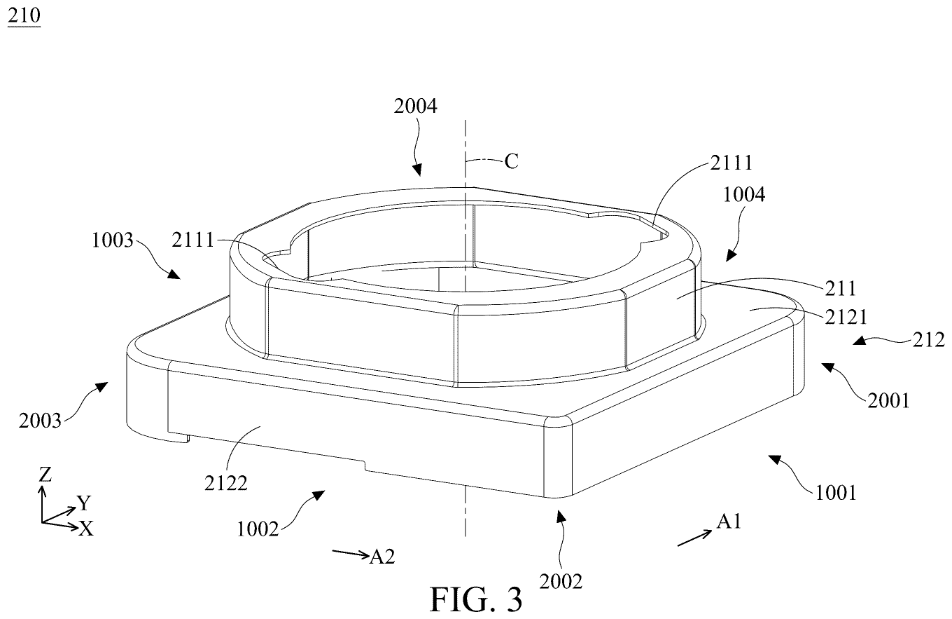

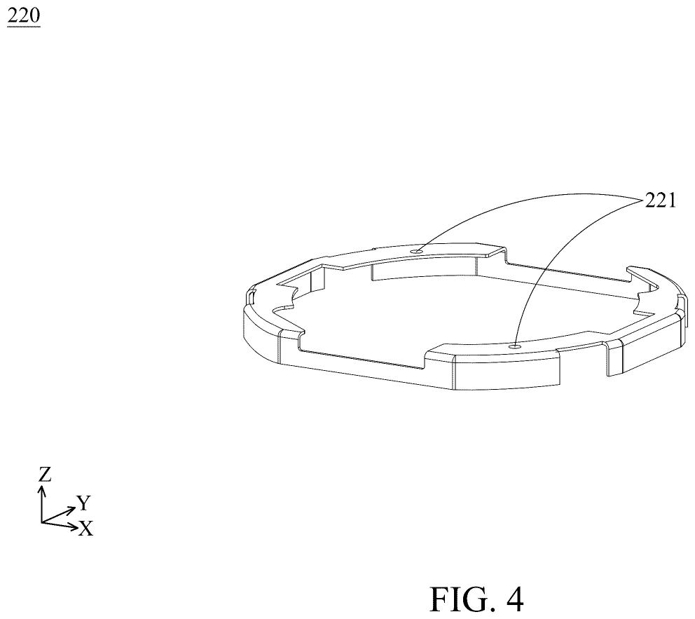

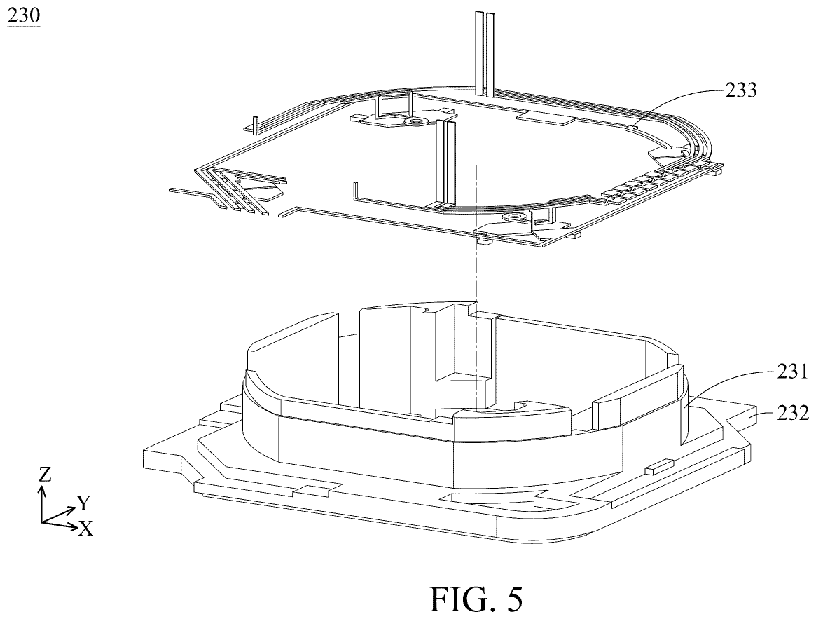

Next, in addition to FIG. 1 and FIG. 2, please refer to FIG. 3 to FIG. 5 to understand the immovable part 200. FIG. 3 is a schematic view of the casing 210 in accordance with some embodiments. FIG. 4 is a schematic view of the mounting element 220 in accordance with some embodiments. FIG. 5 is a schematic view of the bottom 230 in accordance with some embodiments.

The casing 210 may accommodate the bottom 230, the first movable part 310, the elastic assembly 400, the first drive assembly 500, etc. The casing 210 may be made of plastic or metal. The casing 210 includes a casing upper portion 211 and a casing lower portion 212. The casing upper portion 211 may have a circular or polygonal profile. The casing lower portion 212 may have a polygonal profile, such as quadrilateral. From a top-down view, the casing upper portion 211 is positioned within the boundaries of the casing lower portion 212.

The casing upper portion 211 includes two casing recesses 2111. The two casing recesses 2111 are formed near the first corner 2001 and the third corner 2003, respectively. The casing lower portion 212 includes a top wall 2121 and a plurality of side walls 2122. The top wall 2121 is perpendicular to the central axis C. The side walls 2122 extend along the central axis C from the edges of the top wall 2121.

The mounting element 220 is disposed between the casing 210 and the first movable part 310. The mounting element 220 may at least partially cover the top surface of the first movable part 310 and the top surface of the bottom 230. In some embodiments, an adhesive (such as glue) may be applied to the surface of the mounting element 220 that faces the bottom 230 (for example, a plurality of inner surfaces of the mounting element 220) first, and the mounting element 220 is subsequently disposed on the bottom 230. The mounting element 220 may include metal. In some embodiments, the mounting element 220 is manufactured using stamping processes.

In some embodiments, the surfaces of casing 210 and the mounting element 220 that face each other (for example, the inner surface of the casing upper portion 211 and the top surface of the mounting element 220) include an anti-reflective material to reduce stray light. The mounting element 220 includes two mounting-element holes 221. The two mounting-element holes 221 are formed close to the second corner 2002 and the fourth corner 2004, respectively.

The bottom 230 is disposed between the first movable part 310 and the second movable part 320. The bottom 230 may accommodate the first movable part 310. The bottom 230 includes a bottom upper portion 231 and a bottom lower portion 232. The bottom upper portion 231 may have a circular or polygonal profile, which may be similar to the profile or shape of the first movable part 310. The bottom lower portion 232 may have a polygonal profile, such as quadrilateral. From a top-down view, the bottom upper portion 231 is positioned within the boundaries of the bottom lower portion 232.

The bottom 230 may further include an embedded circuit 233 embedded therein. In some embodiments, the embedded circuit 233 may be formed in the bottom 230 by insert molding. The embedded circuit 233 may be made of a conductive material, such as metal. For ease of explanation, the embedded circuit 233 is illustrated separately in FIG. 5. It should be noted that the embedded circuit 233 is actually embedded in the bottom 230.

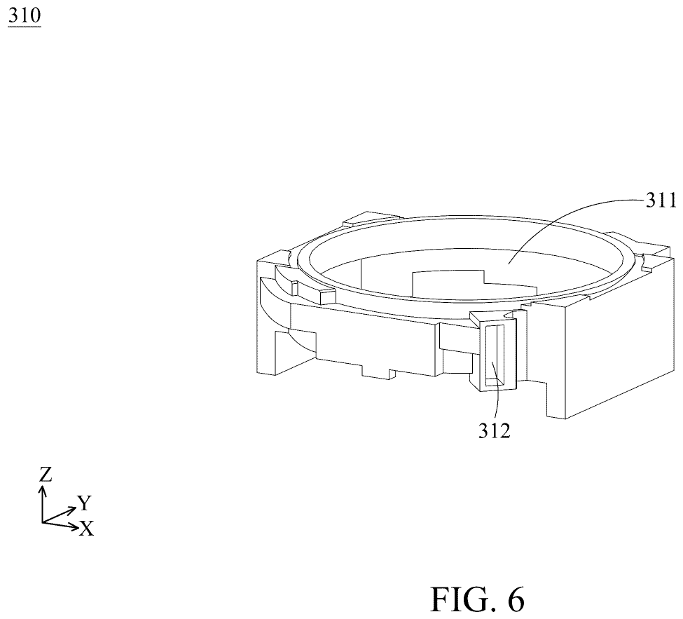

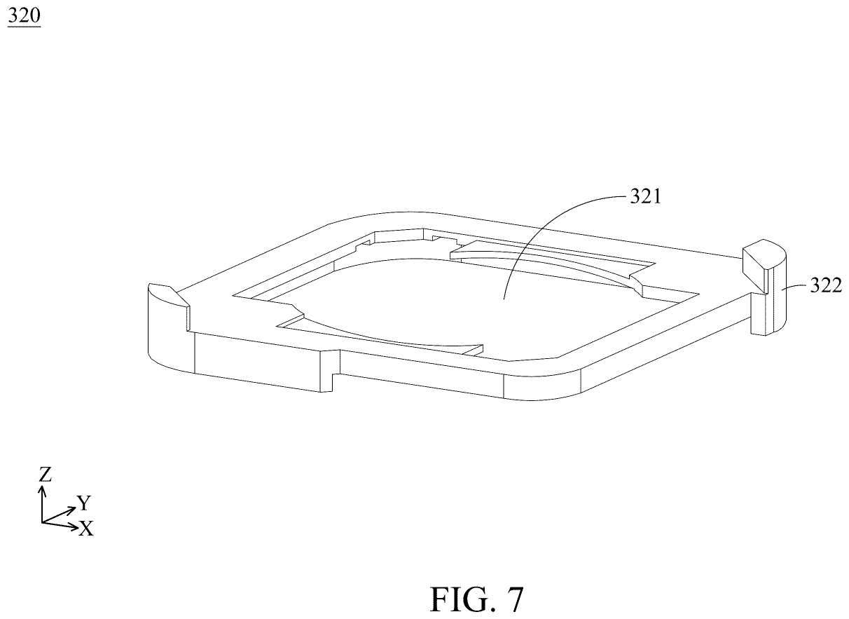

Next, in addition to FIG. 1 and FIG. 2, please also refer to FIG. 6 and FIG. 7 to understand the first movable part 310 and the second movable part 320. FIG. 6 is a perspective view of the first movable part 310 in accordance with some embodiments. FIG. 7 is a perspective view of the second movable part 320 in accordance with some embodiments.

The first movable part 310 includes a first-movable-part opening 311 and two first-movable-part recesses 312. The first-movable-part opening 311 can house the first optical element. The two first-movable-part recesses 312 are formed near the second corner 2002 and the fourth corner 2004, respectively. Only one first-movable-part recess 312 is shown in FIG. 6 due to the perspective. The portions of the first movable part 310 near the first side 1001 and the third side 1003 have a straight-line segment, and the portions of the first movable part 310 near the second side 1002 and the fourth side 1004 have a curved-line segment.

The second movable part 320 includes a second-movable-part opening 321 and two second-movable-part pillars 322. The second-movable-part opening 321 can house the second optical element. The two second-movable-part pillars 322 are positioned near the first corner 2001 and the third corner 2003, respectively.

Please refer to FIG. 2 to understand the elastic assembly 400. The first elastic elements 410, the pop-up elastic elements 420, and the second elastic elements 430 are made of elastic materials or flexible materials, such as metal. In the technical field, the first elastic elements 410, the pop-up elastic elements 420, and the second elastic elements 430 may be referred to as “springs” or “plate-like springs.”

In some embodiments, there are four first elastic elements 410, grouped in two pairs. For example, one pair of two first elastic elements 410 is positioned near the second side 1002, and the other pair of two first elastic elements 410 is positioned near the fourth side 1004.

Each first elastic element 410 includes a portion connected to the bottom 230 (not labeled), a portion connected to the first movable part 310 (not labeled), and a deformable portion therebetween. Similarly, each second elastic element 430 includes a portion connected to the bottom 230 (not labeled), a portion connected to the second movable part 320 (not labeled), and a deformable portion therebetween.

The first elastic elements 410 and the second elastic elements 430 can deform due to the extension or shrinkage of their deformation portions. Due to the first elastic elements 410 and the second elastic elements 430, when the first movable part 310 and/or the second movable part 320 are driven to move relative to the immovable part 200, the range of motion of the first movable part 310 and/or the second movable part 320 is restricted. Therefore, the first movable part 310 and/or the second movable part 320 are prevented from being damaged because of collision with other elements when the optical element drive mechanism 100 moves or is impacted.

The pop-up elastic elements 420 are disposed between the first movable part 310 and the second movable part 320. The two pop-up elastic elements 420 are disposed near the second side 1002 and the fourth side 1004, respectively.

Next, please still refer to FIG. 2 to understand the first drive assembly 500. The first-side coil 510 and the third-side coil 530 may include or may be a coil wound with enameled wire, FP coils, etc., and may be a combination with a flexible printed circuit board (FPC), a flex-rigid composite board, etc. In some embodiments, both the first-side coil 510 and the third-side coil 530 are a combination of FP coils and an FPC.

The first-side magnetic element 520 and the third-side magnetic element 540 may be magnets. In some embodiments, the first-side magnetic element 520 and the third-side magnetic element 540 may be magnetic elements arranged in a Halbach magnetic array.

The first-side coil 510 and the first-side magnetic element 520 are disposed on the first side 1001. The position of the first-side coil 510 corresponds to the position of the first-side magnetic element 520. The third-side coil 530 and the third-side magnetic element 540 are disposed on the third side 1003. The position of the third-side coil 530 corresponds to the position of the third-side magnetic element 540.

The driving force (magnetic force) generated between the first-side coil 510 and the first-side magnetic element 520 and the driving force (magnetic force) generated between the third-side coil 530 and the third-side magnetic element 540 can drive the first movable part 310 together with the first optical element to move relative to the immovable part 200 along the central axis C.

Since the first-side magnetic element 520, the third-side magnetic element 540, and the two pop-up elastic elements 420 are respectively disposed on different sides of the optical element drive mechanism 100, space can be effectively utilized and miniaturization can be achieved.

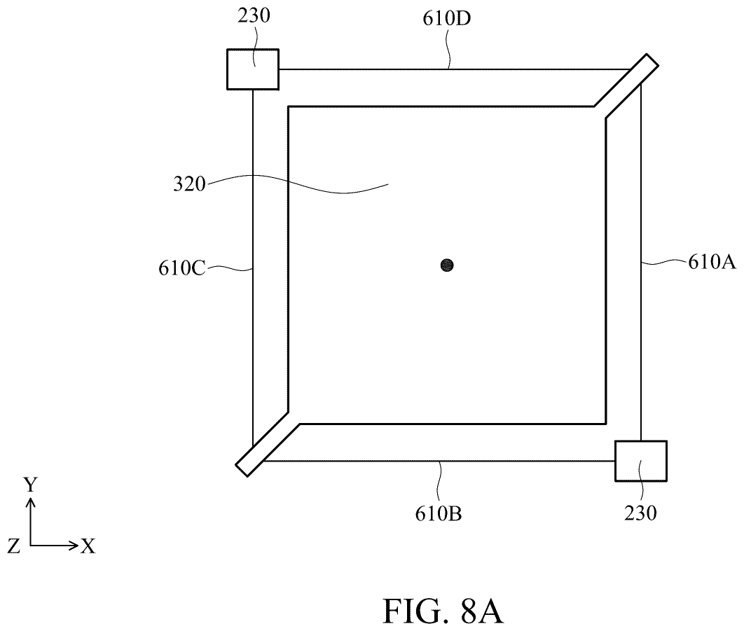

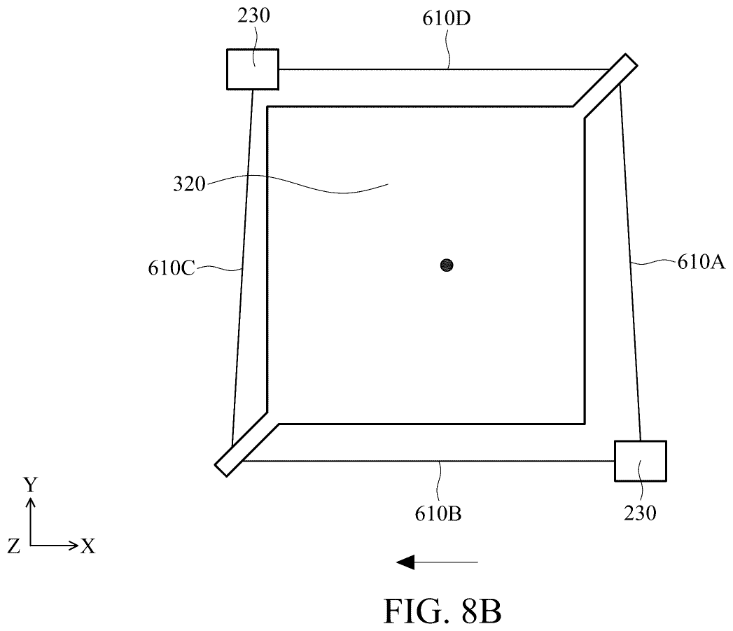

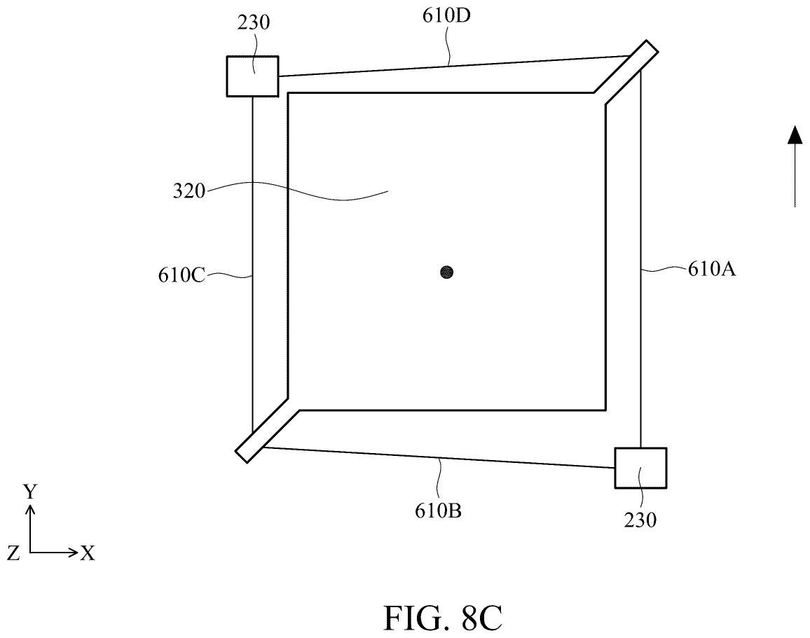

Next, in addition to FIG. 1 and FIG. 2, please also refer to FIG. 8A, FIG. 8B, and FIG. 8C to understand the second drive assembly 600. FIG. 8A, FIG. 8B, and FIG. 8C are schematic views illustrating the operation of the second drive assembly 600 in driving the second movable part 320 in accordance with some embodiments.

The drive elements 610 are disposed below the second movable part 320. In some embodiments, the second drive assembly 600 includes four drive elements 610 disposed on the first side 1001, the second side 1002, the third side 1003, and the fourth side 1004, respectively. In some embodiments, the drive elements 610 are made of a shape memory alloy (SMA), for example, an iron-based alloy, a copper-based alloy (for example, a copper-zinc-aluminum alloy, a copper-aluminum-nickel alloy), a titanium-nickel alloy, a titanium-palladium alloy, a titanium-nickel-copper alloy, a titanium-nickel-palladium alloy, a gold-cadmium alloy, an indium-thallium alloy, or a combination thereof.

The shape memory alloy deforms when the temperature changes. Therefore, the same or different driving signal may be applied to the four drive elements 610 to independently control the temperature of each drive element 610, thereby changing the length of each drive element 610. For example, when a driving signal is applied to change the temperature of the drive elements 610, the lengths of the drive elements 610 are extended or shortened, thereby driving the second movable part 320 and the second optical element on the second movable part 320 to move. As a result, the positional relationship of the second movable part 320 relative to the immovable part 200 is altered. When the driving signal is no longer applied, each drive element 610 returns to its original length

It should be noted that two ends of each of the drive elements 610 are respectively connected to the bottom 230 and the second movable part 320. When the lengths of the drive elements 610 change, the bottom 230 remains stationary. For ease of explanation, FIG. 8A to FIG. 8C illustrate the bottom 230 and the second movable part 320 in a rather simplified manner, and the four drive elements 610 are further defined as a first drive element 610A, a second drive element 610B, a third drive element 610C, and a fourth drive element 610D.

As shown in FIG. 8A, at this time, no driving signal is applied, and the first drive element 610A, the second drive element 610B, the third drive element 610C, and the fourth drive element 610D all maintain their original lengths and are symmetrically arranged in pairs.

As shown in FIG. 8B, when the applied driving signal causes the second drive element 610B to extend and the fourth drive element 610D to shorten, the second movable part 320 can perform position correction and displacement compensation relative to the immovable part 200 in the direction indicated by the arrow (negative X-axis). It can be inferred from FIG. 8B that when the length of the second drive element 610B is shortened and the length of the fourth drive element 610D is lengthened, the second movable part 320 can perform position correction and displacement compensation relative to the immovable part 200 toward the positive X-axis.

As shown in FIG. 8C, when the applied driving signal causes the length of the first drive element 610A to lengthen and the length of the third drive element 610C to shorten, the second movable part 320 can perform position correction and displacement compensation relative to the immovable part 200 in the direction indicated by the arrow (positive Y-axis). It can be inferred from FIG. 8C that when the length of the first drive element 610A is extended and the length of the third drive element 610C is shortened, the second movable part 320 can perform position correction and displacement compensation relative to the immovable part 200 toward the negative Y-axis.

In summary, by applying appropriate driving signals to the first drive assembly 500 and/or the second drive assembly 600, the first drive assembly 500 can drive the first movable part 310 to move relative to the immovable part 200 along a direction parallel with the central axis C, and the second drive assembly 600 can drive the second movable part 320 to move relative to the immovable part 200 along a direction perpendicular to the central axis C. In this technical field, the movement of the second optical element, caused by the motion of the second movable part 320 with respect to the immovable part 200 along a direction perpendicular to the central axis C, is referred to as sensor shift.

The image quality produced by the optical element drive mechanism 100 can be enhanced through the movement of the first movable part 310 and/or the second movable part 320. Additionally, the first drive assembly 500 and the second drive assembly 600 can generate relatively large driving forces, enabling the optical element drive mechanism 100 to support larger or heavier optical elements. In some embodiments, the second optical element may be a one-inch image sensor.

Next, please refer to FIG. 2 alone to understand the guiding assembly 700 and the position sensing assembly 800.

The second-corner guiding element 710 and the fourth-corner guiding element 730 may have substantially the same structure. The second-corner guiding element 710 and the fourth-corner guiding element 730 may have a long strip structure extending along the central axis C, such as rod-like or a bar-like. The second-corner guiding element 710 and the fourth-corner guiding element 730 may include metal or plastic.

The second-corner magnetic element 720 and the fourth-corner magnetic element 740 may have substantially the same structure. The second-corner magnetic element 720 and the fourth-corner magnetic element 740 may be polygonal. The second-corner magnetic element 720 and the fourth-corner magnetic element 740 may be magnetically-permeable elements or magnets. A magnetically-permeable element refers to an element including a material with high magnetic permeability, such as ferromagnetic materials, including iron (Fe), nickel (Ni), cobalt (Co), or an alloy thereof.

The second-corner guiding element 710 and the second-corner magnetic element 720 are disposed near the second corner 2002. The fourth-corner guiding element 730 and the fourth-corner magnetic element 740 are disposed near the fourth corner 2004. In some embodiments, the second-corner magnetic element 720 and the fourth-corner magnetic element 740 are respectively disposed in the two first-movable-part recesses 312 of the first movable part 310.

The second-corner magnetic element 720 can generate magnetic attraction force with the first-side magnetic element 520, and the fourth-corner magnetic element 740 can generate magnetic attraction with the third-side magnetic element 540, so that the second-corner guiding element 710 and the fourth-corner guiding element 730 are in close contact with the first movable part 310. As a result, it is ensured that the first movable part 310 moves relative to the immovable part 200 along the central axis C, and the possibility of the first movable part 310 generating unwanted shaking is reduced.

In some embodiments, the top of the second-corner guiding element 710 and the top of the fourth-corner guiding element 730 can be respectively connected to the two mounting-element holes 221 (for example, by welding) to reduce the possibility of the second-corner guiding element 710 and the fourth-corner guiding element 730 falling off from the optical element drive mechanism 100.

The guiding spherical elements 750 and the guiding magnetic elements 760 are disposed between the bottom 230 and the second movable part 320. The guiding spherical elements 750 and the guiding magnetic elements 760 can ensure the second movable part 320 to move relative to the immovable part 200 on a plane perpendicular to the central axis C.

When the first movable part 310 moves relative to the immovable part 200, the position of the first movable part 310 can be detected by the position sensing assembly 800. The position sensing element 810 may be disposed near the first corner 2001. In some embodiments, the position sensing element 810 may be a Hall sensing element, a Giant Magneto Resistance (GMR) sensing element, a Tunneling Magneto Resistance (TMR) sensing element, etc.

The position sensing element 810 obtains the position of the first movable part 310 by sensing the change of magnetic lines of force (including but not limited to the density and direction of magnetic lines of force) of the first-side magnetic element 520. Since the second-corner guiding element 710 for guiding the first movable part 310, the fourth-corner guiding element 730 for guiding the first movable part 310, and the position sensing element 810 for sensing the first movable part 310 are disposed at different corners of the optical element drive mechanism 100, space can be effectively utilized and miniaturization can be achieved.

It should be noted that the first-side magnetic element 520 is a drive magnetic element of the first drive assembly 500 and a reference magnetic element of the position sensing assembly 800. That is, a single magnetic element can have multiple functions, so the volume of the optical element drive mechanism 100 can be reduced to further achieve miniaturization.

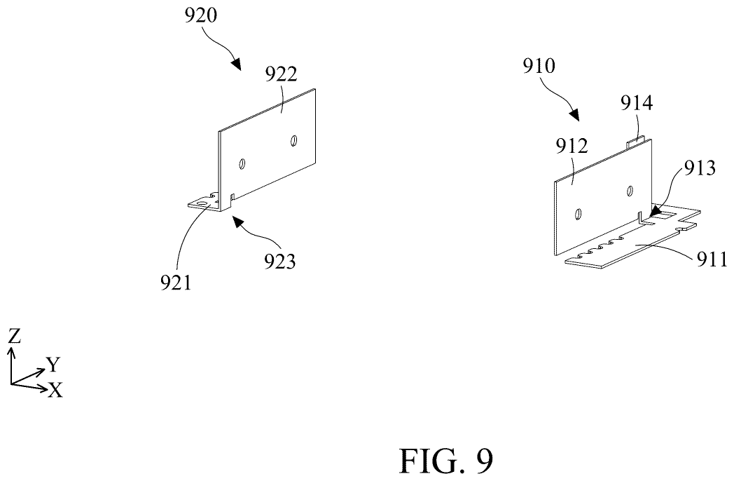

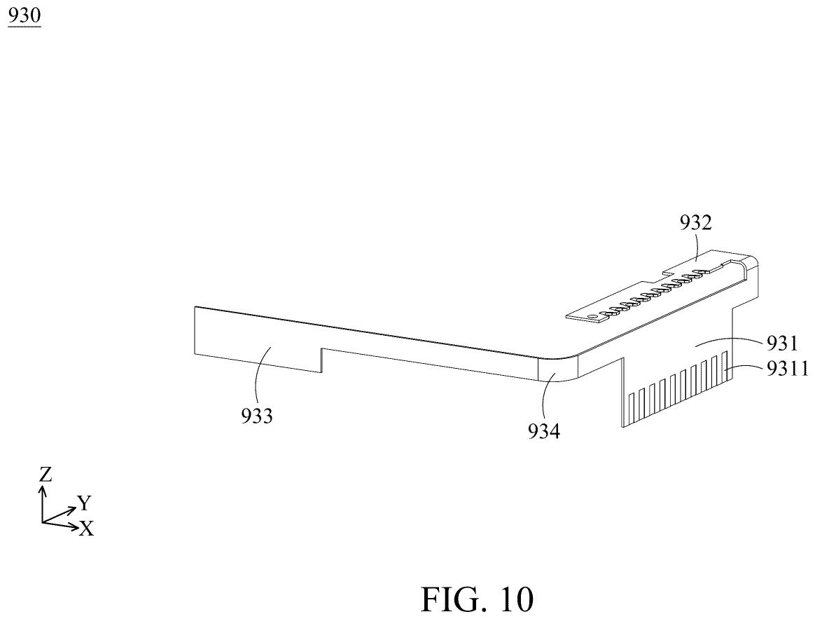

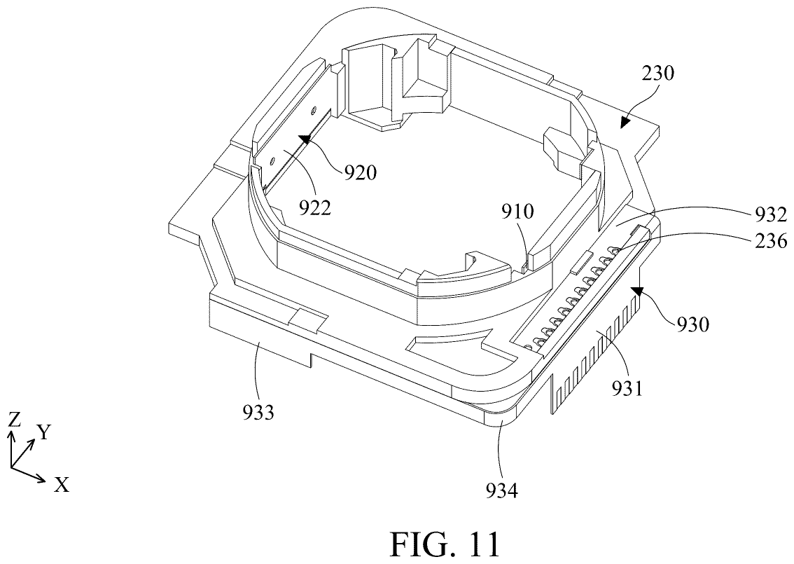

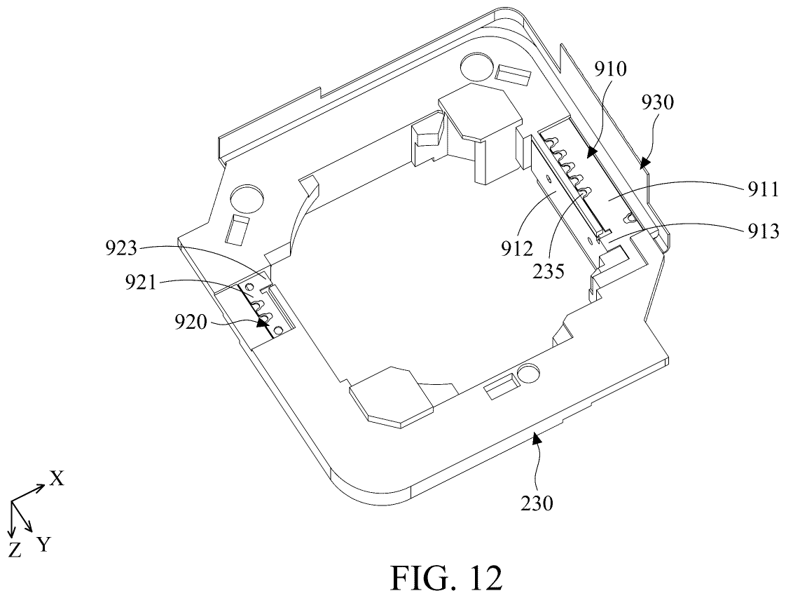

Next, in addition to FIG. 2, please also refer to FIG. 9, FIG. 10, FIG. 11, and FIG. 12 to understand the circuit assembly 900. FIG. 9 is a schematic view of the first-side circuit element 910 and the third-side circuit element 920 in accordance with some embodiments. FIG. 10 is a schematic view of the external connection circuit element 930 in accordance with some embodiments. FIG. 11 and FIG. 12 are schematic views of the bottom 230 and the circuit assembly 900 from different perspectives in accordance with some embodiments.

The first-side circuit element 910 is disposed on the first side 1001. The first-side circuit element 910 may be an FPC. The first-side circuit element 910 is electrically connected to the first drive assembly 500 and the embedded circuit 233 embedded in the bottom 230. The first-side circuit element 910 includes a first portion of the first-side circuit element 911, a second portion of the first-side circuit element 912, a bent portion of the first-side circuit element 913, and a protruding portion of the first-side circuit element 914.

The first portion of the first-side circuit element 911 has a plate-like structure. The first portion of the first-side circuit element 911 is perpendicular to the central axis C. The first portion of the first-side circuit element 911 is disposed on the bottom 230. For example, the first portion of the first-side circuit element 911 may directly contact a bottom first surface 235 (only labeled in FIG. 12) of the bottom 230 that faces the first portion of the first-side circuit element 911.

Specifically, the bottom first surface 235 faces the second movable part 320. In some embodiments, when viewed along a direction that is perpendicular to the central axis C, the bottom first surface 235 is located between the center of the first movable part 310 and the bottom surface of the first portion of the first-side circuit element 911. In other words, the center of the first movable part 310 is closer to the top wall 2121 of the casing 210 than the bottom first surface 235, and the bottom surface of the first portion of the first-side circuit element 911 is closer to the second movable part 320 than the bottom first surface 235.

The second portion of the first-side circuit element 912 has a plate-like structure. The second portion of the first-side circuit element 912 is substantially parallel with the central axis C. That is, the second portion of the first-side circuit element 912 is not parallel with the first portion of the first-side circuit element 911. The second portion of the first-side circuit element 912 is disposed on the bottom 230. For example, the second portion of the first-side circuit element 912 may directly contact a bottom side surface (not shown) of the bottom 230 that faces the second portion of the first-side circuit element 912. Specifically, the bottom side surface faces the first movable part 310.

The first drive assembly 500 is electrically connected to the first portion of the first-side circuit element 911 via the second portion of the first-side circuit element 912. That is, the current flowing out from the first drive assembly 500 first flows through the second portion of the first-side circuit element 912 and then flows into the first portion of the first-side circuit element 911.

The first-side coil 510 includes an outer surface of the first-side coil 515 (only labeled in FIG. 2) facing the second portion of the first-side circuit element 912. When viewed along a direction that is perpendicular to the center axis C, the outer surface of the first-side coil 515 at least partially overlaps the first portion of the first-side circuit element 911. Furthermore, when viewed along a direction that is perpendicular to the central axis C, the center of the outer surface of the first-side coil 515 is located between the position sensing element 810 and the second-corner guiding element 710. In other words, the position sensing element 810 is closer to the first corner 2001 than the center of the outer surface of the first-side coil 515, and the second-corner guiding element 710 is closer to the second corner 2002 than the center of the outer surface of the first-side coil 515.

The bent portion of the first-side circuit element 913 may be connected to the first portion of the first-side circuit element 911 and the second portion of the first-side circuit element 912.

The protruding portion of the first-side circuit element 914 has a plate-like structure. The protruding portion of the first-side circuit element 914 is not parallel with the first portion of the first-side circuit element 911, and the protruding portion of the first-side circuit element 914 is parallel with the second portion of the first-side circuit element 912. When viewed along a direction that is perpendicular to the central axis C, the protruding portion of the first-side circuit element 914 does not overlap the second portion of the first-side circuit element 912. In some embodiments, the position sensing element 810 may be disposed on the protruding portion of the first-side circuit element 914. Therefore, the position sensing assembly 800 may be electrically connected to the first portion of the first-side circuit element 911 via the protruding portion of the first-side circuit element 914.

The third-side circuit element 920 is disposed on the third side 1003. The third-side circuit element 920 may be an FPC. The third-side circuit element 920 includes a first portion of the third-side circuit element 921, a second portion of the third-side circuit element 922, and a bent portion of the third-side circuit element 923 similar to the first portion of the first-side circuit element 911, the second portion of the first-side circuit element 912, and the bent portion of the first-side circuit element 913.

The primary difference between the third-side circuit element 920 and the first-side circuit element 910 is that the third-side circuit element 920 may lack a protruding portion. This is because, in the present disclosure, only a single position sensing element (e.g., the position sensing element 810 described above) is required to detect the movement of the first movable part 310 relative to the immovable part 200 along the central axis C. Consequently, only one protruding portion of the circuit element is necessary for the placement of the single position sensing element.

The first-side circuit element 910 is electrically connected to an external circuit via the external connection circuit element 930. The external connection circuit element 930 includes a first portion of the external connection circuit element 931, a second portion of the external connection circuit element 932, a third portion of the external connection circuit element 933, and a movable portion of the external connection circuit element 934.

The first portion of the external connection circuit element 931 has a plate-like structure. The first portion of the external connection circuit element 931 is parallel with the central axis C. The first portion of the external connection circuit element 931 is disposed on the first side 1001. The first portion of the external connection circuit element 931 may have a plurality of pins 9311 electrically connected to the external circuit. Since the pins 9311 and the first-side magnetic element 520 are located on the same side, the optical element drive mechanism 100 can be conveniently positioned alongside other optical element drive mechanisms and/or optical modules within an electronic device, while minimizing magnetic interference.

The second portion of the external connection circuit element 932 has a plate-like structure. The second portion of the external connection circuit element 932 is perpendicular to the central axis C. The second portion of the external connection circuit element 932 is not parallel with the first portion of the external connection circuit element 931. In some embodiments, the second portion of the external connection circuit element 932 is perpendicular to the first portion of the external connection circuit element 931. In some embodiments, the second portion of the external connection circuit element 932 and the first portion of the first-side circuit element 911 are parallel with each other.

The second portion of the external connection circuit element 932 is electrically connected to the external circuit via the first portion of the external connection circuit element 931. That is, the current flowing in from the external circuit first flows through the first portion of the external connection circuit element 931 and then flows into the second portion of the external connection circuit element 932.

The second portion of the external connection circuit element 932 is disposed on the first side 1001. The second portion of the external connection circuit element 932 is disposed on the bottom 230. For example, the second portion of the external connection circuit element 932 may directly contact a bottom second surface 236 (only labeled in FIG. 11) of the bottom 230 that faces the second portion of the external connection circuit element 932.

Specifically, the bottom second surface 236 faces the top wall 2121 of the casing 210. In some embodiments, when viewed along a direction that is perpendicular to the central axis C, the bottom second surface 236 is located between the center of the first movable part 310 and the bottom first surface 235. In other words, the center of the first movable part 310 is closer to the top wall 2121 of the casing 210 than the bottom second surface 236, and the bottom first surface 235 is closer to the second movable part 320 than the bottom second surface 236.

The third portion of the external connection circuit element 933 has a plate-like structure. The third portion of the external connection circuit element 933 is not parallel with the first portion of the external connection circuit element 931 and the second portion of the external connection circuit element 932. The third portion of the external connection circuit element 933 is disposed on the second side 1002. The third portion of the external connection circuit element 933 is disposed on the second movable part 320. For example, the third portion of the external connection circuit element 933 may directly contact an outer surface (not labeled) of the second movable part 320 that faces the third portion of the external connection circuit element 933.

The movable portion of the external connection circuit element 934 is connected to the first portion of the external connection circuit element 931 and the third portion of the external connection circuit element 933. In some embodiments, the movable portion of the external connection circuit element 934 surrounds the second corner 2002. In some embodiments, the movable portion of the external connection circuit element 934 may not contact any other element. That is, the movable portion of the external connection circuit element 934 is suspended in mid-air.

In some embodiments, when viewed along a direction that is perpendicular to the central axis C, the bottom first surface 235 and the bottom second surface 236 are located between the second portion of the external connection circuit element 932 and the first portion of the first-side circuit element 911. In other words, the bottom first surface 235 and the bottom second surface 236 are sandwiched between the external connection circuit element 930 and the first-side circuit element 910.

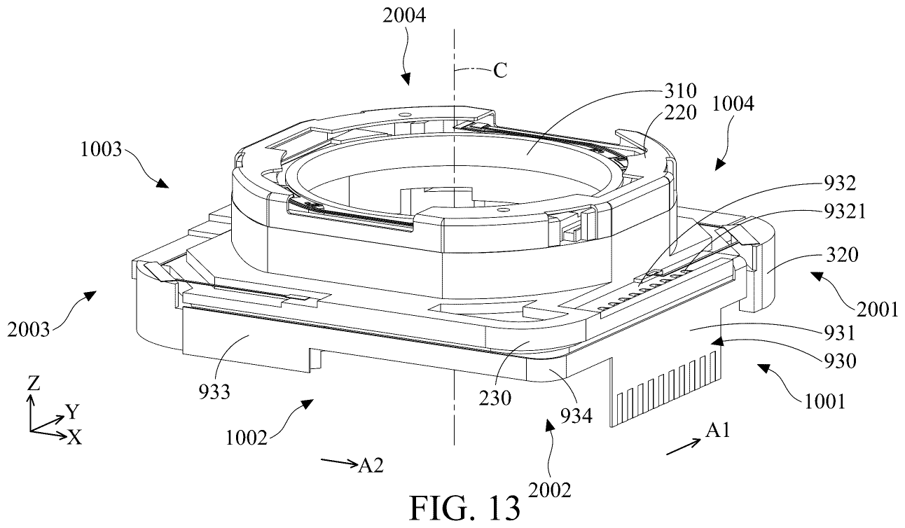

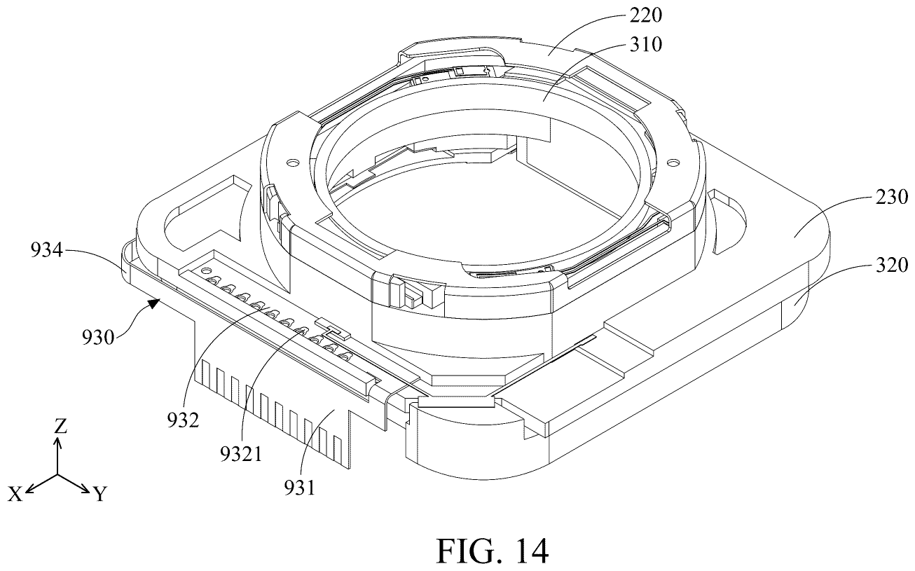

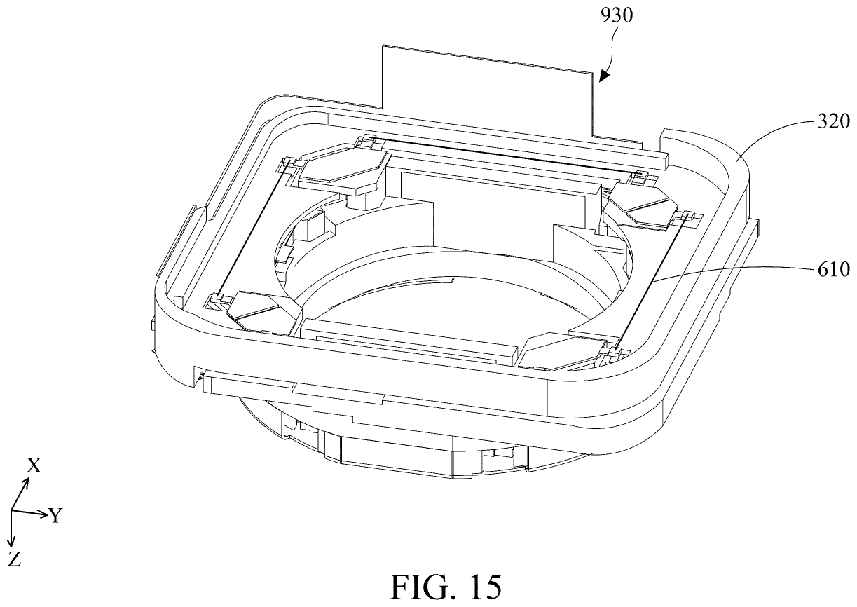

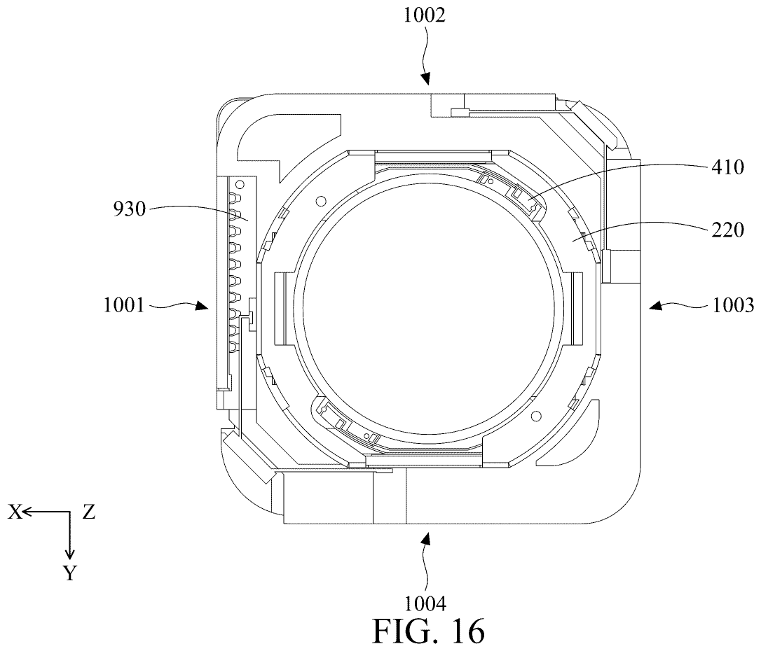

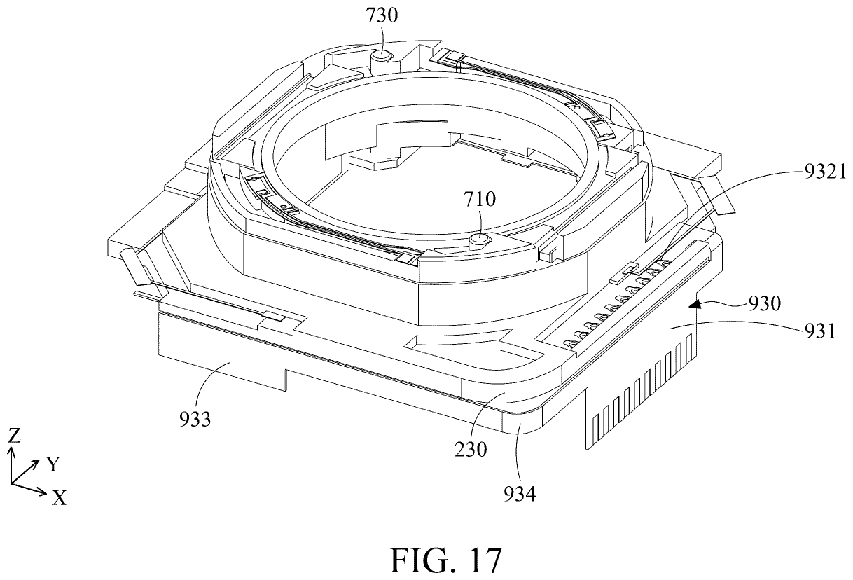

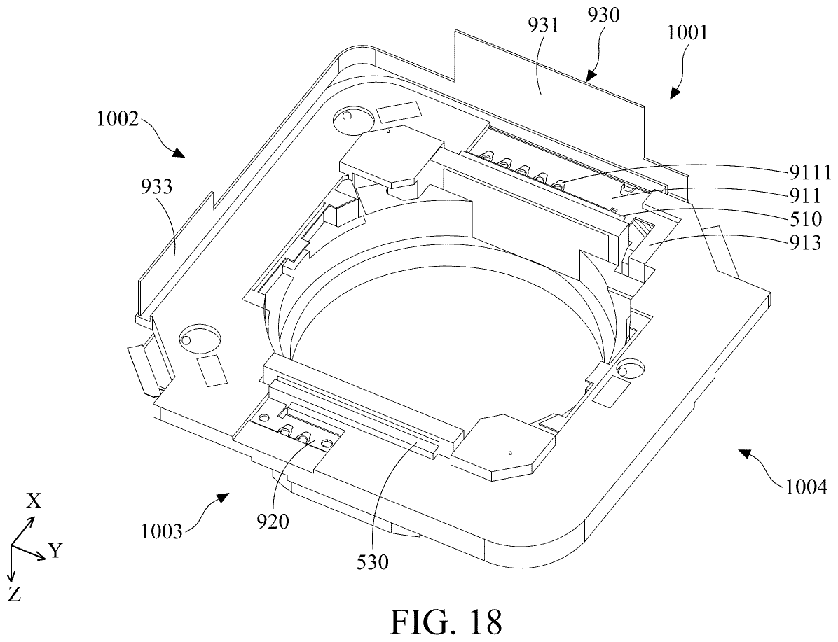

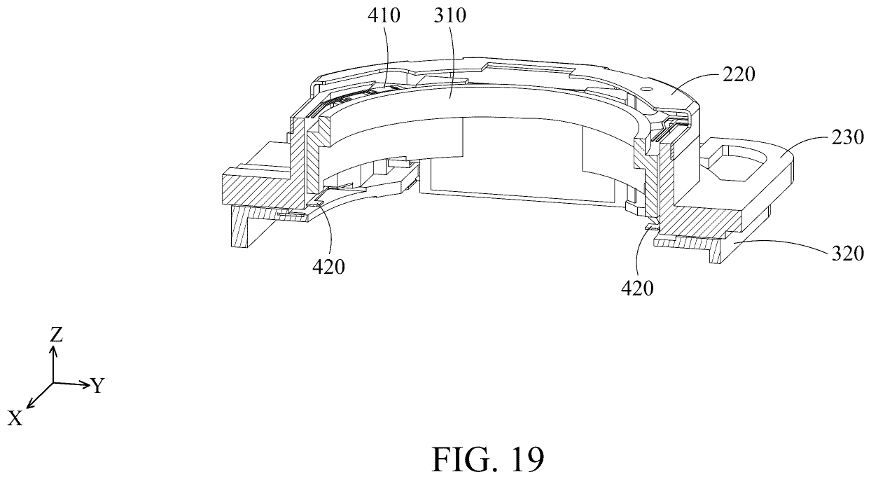

Next, please refer to FIG. 13 to FIG. 19 to understand some other features of the optical element drive mechanism 100, such as the positional relationship between the elements, circuit connection methods, and other details. FIG. 13, FIG. 14, and FIG. 15 are perspective views of the optical element drive mechanism 100 with the casing 210 omitted from different perspectives in accordance with some embodiments. FIG. 16 is a top view of the optical element drive mechanism 100 with the casing 210 omitted in accordance with some embodiments. FIG. 17 and FIG. 18 are perspective views of the optical element drive mechanism 100 with the casing 210, the mounting element 220, and the second movable part 320 omitted in accordance with some embodiments. FIG. 19 is a cross-sectional view of the optical element drive mechanism 100 with the casing 210 omitted in accordance with some embodiments.

The first portion of the first-side circuit element 911 may include an electrical connection portion of the first-side circuit element 9111. The first portion of the first-side circuit element 911 is electrically connected to the embedded circuit 233 of the bottom 230 via the electrical connection portion of the first-side circuit element 9111. Specifically, a solder material (e.g., a solder ball) may be applied on the electrical connection portion of the first-side circuit element 9111, so the electrical connection portion of the first-side circuit element 9111 serves as a soldering point. As a result, the electrical connection of the first-side circuit element 910 is established at the bottom first surface 235 of the bottom 230.

The second portion of the external connection circuit element 932 may include an electrical connection portion of the external connection circuit element 9321. The second portion of the external connection circuit element 932 is electrically connected to the embedded circuit 233 of the bottom 230 via the electrical connection portion of the external connection circuit element 9321. Specifically, a solder material (e.g., a solder ball) may be applied on the electrical connection portion of the external connection circuit element 9321, so the electrical connection portion of the external connection circuit element 9321 serves as a soldering point. As a result, the electrical connection of the external connection circuit element 930 is established at the bottom second surface 236 of the bottom 230.

In some embodiments, when viewed along a direction that is perpendicular to the central axis C, the electrical connection portion of the first-side circuit element 9111 and the electrical connection portion of the external connection circuit element 9321 do not overlap. That is, the electrical connection portion of the first-side circuit element 9111 and the electrical connection portion of the external connection circuit element 9321 are located at different horizontal planes.

In summary, the first-side circuit element 910 is electrically connected to the embedded circuit 233 of the bottom 230 and the first drive assembly 500 at the bottom first surface 235 of the bottom 230 via the electrical connection portion of the first-side circuit element 9111. Similarly, the external connection circuit element 930 is electrically connected to the embedded circuit 233 of the bottom 230 at the bottom second surface 236 via the electrical connection portion of the external connection circuit element 9321. As a result, the circuit assembly 900 can improve circuit designs. Furthermore, the design of the first-side circuit element 910, the third-side circuit element 920, and the external connection circuit element 930 allows for easy assembly of the circuit assembly 900. For example, the first-side circuit element 910 and/or the third-side circuit element 920 may be mounted from bottom to top.

Furthermore, as shown in FIG. 16, the end of one of the first elastic elements 410 may have a receiving structure for receiving the end of another first elastic element 410, which can save materials and reduce waste. In some embodiments, a portion or all of the first elastic element 410 may be exposed to facilitate electrical connection or physical connection with the third optical element.

As shown in FIG. 19, the presence of the pop-up elastic elements 420 divides the movement of the first movable part 310 into a focusing section and a non-focusing section. When the first movable part 310 compresses the pop-up elastic elements 420, its movement corresponds to the non-focusing section.

In summary, the present disclosure provides an optical element drive mechanism that drives different optical elements to move by using different driving assemblies. These drive assemblies can generate relatively large driving forces, enabling the optical element drive mechanism to support larger or heavier optical elements. The circuit assembly includes a plurality of circuit elements. The circuit assembly can improve circuit designs. Furthermore, the design of the circuit assembly allows for easy assembly. Besides, the elastic assembly include pop-up elastic elements. Furthermore, the arrangement of assemblies can effectively utilize space and achieve miniaturization.

The foregoing outlines features of several embodiments, so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced in the following description. Those skilled in the art should also realize that such equivalent constructions do not depart from the spirit and scope of the present disclosure, and that they may make various changes, substitutions, and alterations in the following description without departing from the spirit and scope of the present disclosure.

What is claimed is:

1. An optical element drive mechanism having a central axis, comprising:
an immovable part comprising a bottom;
a first movable part connected to a first optical element, wherein the first movable part is movable relative to the bottom; and
a first drive assembly driving the first movable part to move relative to the bottom.

2. The optical element drive mechanism as claimed in claim 1, further comprising a first-side circuit element electrically connected to the first drive assembly, wherein the bottom comprises an embedded circuit, and the first-side circuit element comprises:
a first portion of the first-side circuit element having a plate-like structure, wherein the first portion of the first-side circuit element is disposed on the bottom,
wherein the first portion of the first-side circuit element comprises an electrical connection portion of the first-side circuit element, and the first portion of the first-side circuit element is electrically connected to the embedded circuit of the bottom via the electrical connection portion of the first-side circuit element, and
wherein the bottom comprises a bottom first surface facing the first portion of the first-side circuit element, and when viewed along a direction that is perpendicular to the central axis, the bottom first surface is located between a center of the first movable part and the first portion of the first-side circuit element.

3. The optical element drive mechanism as claimed in claim 2, wherein the first-side circuit element further comprises:
a second portion of the first-side circuit element having a plate-like structure and not parallel with the first portion of the first-side circuit element; and
a bent portion of the first-side circuit element connected to the first portion of the first-side circuit element and the second portion of the first-side circuit element,
wherein the first drive assembly is electrically connected to the first portion of the first-side circuit element via the second portion of the first-side circuit element, and
wherein the first drive assembly comprises a first-side coil, the first-side coil has an outer surface of the first-side coil facing the second portion of the first-side circuit element, and when viewed along a direction that is perpendicular to the central axis, the outer surface of the first-side coil at least partially overlaps the first portion of the first-side circuit element.

4. The optical element drive mechanism as claimed in claim 3, wherein the first-side circuit element further comprises:
a protruding portion of the first-side circuit element having a plate-like structure, not parallel with the first portion of the first-side circuit element, and parallel with the second portion of the first-side circuit element,
wherein when viewed along a direction that is perpendicular to the central axis, the protruding portion of the first-side circuit element does not overlap the second portion of the first-side circuit element.

5. The optical element drive mechanism as claimed in claim 4, further comprising a position sensing assembly sensing the movement of the first movable part, wherein the position sensing assembly comprises a position sensing element disposed on the protruding portion of the first-side circuit element, and the position sensing assembly is electrically connected to the first portion of the first-side circuit element via the protruding portion of the first-side circuit element.

6. The optical element drive mechanism as claimed in claim 3, further comprising a guiding assembly guiding the movement of the first movable part relative to the bottom and a position sensing element sensing the movement of the first movable part, wherein the guiding assembly comprises a second-corner guiding element, and when viewed along a direction that is perpendicular to the central axis, a center of the outer surface of the first-side coil is located between the position sensing element and the second-corner guiding element.

7. The optical element drive mechanism as claimed in claim 2, further comprising an external connection circuit element, wherein the first-side circuit element is electrically connected to an external circuit via the external connection circuit element, and the external connection circuit element comprises:
a first portion of the external connection circuit element having a plate-like structure; and
a second portion of the external connection circuit element having a plate-like structure and not parallel with the first portion of the external connection circuit element,
wherein the second portion of the external connection circuit element comprises an electrical connection portion of the external connection circuit element, and the second portion of the external connection circuit element is electrically connected to the embedded circuit of the bottom via the electrical connection portion of the external connection circuit element,
wherein the second portion of the external connection circuit element is electrically connected to the external circuit via the first portion of the external connection circuit element, and
wherein the second portion of the external connection circuit element is parallel with the first portion of the first-side circuit element.

8. The optical element drive mechanism as claimed in claim 7, wherein when viewed along a direction that is perpendicular to the central axis, the bottom first surface is located between the first portion of the first-side circuit element and the second portion of the external connection circuit element, and when viewed along a direction that is perpendicular to the central axis, the electrical connection portion of the first-side circuit element does not overlap the electrical connection portion of the external connection circuit element.

9. The optical element drive mechanism as claimed in claim 7, further comprising a second movable part connected to a second optical element, wherein the external connection circuit element further comprises:
a third portion of the external connection circuit element having a plate-like structure and neither parallel with the first portion of the external connection circuit element and the second portion of the external connection circuit element; and
a movable portion of the external connection circuit element connected to the third portion of the external connection circuit element,
wherein the bottom is disposed between the first movable part and the second movable part, and the third portion of the external connection circuit element is disposed on the second movable part.

10. The optical element drive mechanism as claimed in claim 1, wherein the immovable part further comprises a casing and a mounting element disposed between the casing and the first movable part, wherein the mounting element at least partially covers a top surface of the first movable part and a top surface of the bottom.

11. The optical element drive mechanism as claimed in claim 10, wherein both the casing and the mounting element comprise an anti-reflective material.

12. The optical element drive mechanism as claimed in claim 10, wherein the mounting element comprises two mounting-element holes located at diagonal corners.

13. The optical element drive mechanism as claimed in claim 12, further comprising a guiding assembly guiding the movement of the first movable part relative to the bottom, wherein the guiding assembly comprises a second-corner guiding element and a fourth-corner guiding element, and a top of the second-corner guiding element and a top of the fourth-corner guiding element are connected to the two mounting-element holes.

14. The optical element drive mechanism as claimed in claim 13, wherein the first movable part comprises two first-movable-part recesses, and the guiding assembly further comprises a second-corner magnetic element and a fourth-corner magnetic element respectively disposed in the two first-movable-part recesses.

15. The optical element drive mechanism as claimed in claim 1, wherein the optical element drive mechanism includes a first side, a second side, a third side opposite to the first side, and a fourth side opposite to the second side, wherein portions of the first movable part near the first side and the third side have a straight-line segment, and portions of the first movable part near the second side and the fourth side have a curved-line segment.

16. The optical element drive mechanism as claimed in claim 15, further comprising an elastic assembly, wherein the elastic assembly comprises two pop-up elastic elements respectively disposed on the second side and the fourth side.

17. The optical element drive mechanism as claimed in claim 16, further comprising a second movable part disposed below the bottom, wherein the second movable part is movable relative to the bottom, and the pop-up elastic elements are located between the first movable part and the second movable part.

18. The optical element drive mechanism as claimed in claim 1, wherein the first drive assembly comprises a first-side coil, and the first-side coil is a combination of FP coils and an FPC.

19. The optical element drive mechanism as claimed in claim 1, further comprising a circuit assembly electrically connected to the first drive assembly, wherein the circuit assembly comprises:
a first-side circuit element comprising a first portion of the first-side circuit element that is perpendicular to the central axis; and
an external connection circuit element comprising a first portion of the external connection circuit element that is parallel with the central axis and a second portion of the external connection circuit element that is perpendicular to the central axis,
wherein part of the bottom is sandwiched between the first portion of the first-side circuit element and the second portion of the external connection circuit element.

20. The optical element drive mechanism as claimed in claim 19, wherein the external connection circuit element further comprises:
a third portion of the external connection circuit element that is parallel with the central axis; and
a movable portion of the external connection circuit element that is connected to the first portion of the external connection circuit element and the third portion of the external connection circuit element,
wherein the third portion of the external connection circuit element is located on a side of the optical element drive mechanism that is different from another side where the first portion of the external connection circuit element and the second portion of the external connection circuit element are located.
